(19) United States
(12) Patent Application Publication
(10) Pub. No.: US 2026/0031922 A1
(43) Pub. Date: Jan. 29, 2026

(54) FlexO Remote Deskew

(71) Applicant: Ciena Corporation, Hanover, MD (US)

(72) Inventors: Sebastien Gareau, Ottawa (CA); Luz Adriana Osorio Cuadros, Ottawa (CA)

(73) Assignee: Ciena Corporation, Hanover, MD (US)

(21) Appl. No.: 18/781,324

(22) Filed: Jul. 23, 2024

(51) Int. Cl. H04J 3/16; H04B 10/079; H04J 14/08

(52) U.S. Cl. CPC H04J 3/1652; H04B 10/0793; H04J 14/08

(57) ABSTRACT

Systems and methods for Flexible Optical Transport Network (FlexO) remote deskew procedure include, at a terminating receiver, detecting relative skew between multiple interfaces in a group in a FlexO network, and signal information based on the detected skew to one or more remote transceivers located in a backwards direction relative to the receiver. At a remote transceiver, the systems and methods include based on detected skew between multiple interfaces in a group in at a terminating receiver, receiving skew information therefrom, and causing alignment of the multiple interfaces based on the received skew information.

### FIELD OF THE DISCLOSURE

The present disclosure relates generally to networking. More particularly, the present disclosure relates to systems and methods for Flexible Optical Transport Network (FlexO) remote deskew.

### BACKGROUND OF THE DISCLOSURE

Flexible Optical Transport Network (OTN), referred to as FlexO, is a Layer 1 protocol that provides a framework for the transmission, multiplexing, framing, and management of various types of data over optical networks. Relevant standards associated with FlexO include (1) International Telecommunication Union-Transmission (ITU-T) Recommendation G.709.1, Flexible OTN common elements (07/2024), (2) ITU-T Recommendation G.709.1, Flexible OTN short-reach interfaces (01/2017 and 06/2018), referred to herein as G.709.1 pre-2020, (3) ITU-T Recommendation G.709.3, Flexible OTN long-reach interfaces (03/2024), (4) ITU-T Recommendation G.709.5, Flexible OTN short-reach interfaces (03/2024), (5) ITU-T Recommendation G.709.6, Flexible OTN B400 G long-reach interfaces (03/2024), and (6) ITU-T Recommendation G.798, Characteristics of optical transport network hierarchy equipment functional blocks (09/2023), the contents of each are incorporated by reference in their entirety. These standards define FlexO regenerators (“regens”) and Optical Transport Unit (OTU) order Cn (OTUCn) regens. An optical regen is a network element that provides optical-electrical-optical (OEO) regeneration and are used at locations where optical signals require signal regeneration. In the context of FlexO, regens introduce complexity in the network, specifically related to deskewing.

### BRIEF SUMMARY OF THE DISCLOSURE

The present disclosure relates to systems and methods for Flexible Optical Transport Network (FlexO) remote deskew. ITU-T G.709.1 FlexO interfaces can support bonding (inverse muxing) of multiple interfaces over a group. As such, a receiver must be able to deskew and align the independent member interfaces within the group. Deskewing is a standard function and can be done at the OTUCn client level (for older implementations) or at the FlexO-n group level (for newer implementations). As described herein, older implementations include G.709.1 pre-2020, and newer implementations include G.709.1 (07/2024). The present disclosure presents a scheme to deskew a group remotely, at either the OTUCn level or FlexO level. Specifically, there are various scenarios, such as the mix of FlexO and OTUCn regens, that are necessitating a new type of remote deskewing scheme. Specifically, the present disclosure addresses drawbacks of the various scenarios (described herein), and provides an approach to introduce a mix of FlexO and OTUCn regens in the network, as well as handling some hybrid regen use cases.

In an embodiment, a receiver is configured to support remote deskew. The receiver includes circuitry configured to detect skew between multiple interfaces in a group in Flexible Optical Transport Network (OTN) (FlexO), and signal information based on the detected skew to one or more remote transceivers located in a backwards direction relative to the receiver. The circuitry can be further configured to signal the information when the detected skew is greater than a value that the receiver can locally deskew. The information can be signaled in FlexO overhead. The information can include a deskew failure indication and a measured relative skew across the multiple interfaces. The deskew failure indication can be in one of a FlexO STAT byte and an Optical Transport Unit (OTU) order Cn (OTUCn) Section Monitoring (SM) status byte. The measured relative skew can be in reserved bytes in FlexO overhead. The measured relative skew can be in increments of time measured with reference to a first arriving instance of the multiple interfaces. In an embodiment, the receiver is in a FlexO network having at least two segments with a first segment being FlexO transparent utilizing ITU-T G.709.1 (07/2024) and a second segment with the receiver terminating FlexO utilizing ITU-T G.709.1 pre-2020. In another embodiment, the receiver is in a FlexO network having multiple FlexO-x regenerator sections. In a further embodiment, the receiver is in a FlexO network having a hybrid FlexO-n regenerator.

In another embodiment, a remote transceiver is configured to support remote deskew in a Flexible Optical Transport Network (OTN) (FlexO) network. The remote transceiver includes circuitry configured to, based on detected skew between multiple interfaces in a group at a terminating receiver, receive relative skew information therefrom, and cause alignment of the multiple interfaces based on the received relative skew information. The skew information can be received when the detected skew at the terminating receiver is greater than a value that the terminating receiver can locally deskew, and wherein the alignment includes compensating for the skew both at the remote transceiver and the terminating receiver. The received relative skew information can be signaled in FlexO overhead. The received relative skew information can include a deskew failure indication and a measured skew across the multiple interfaces. The deskew failure indication can be in one of a FlexO STAT byte and an Optical Transport Unit (OTU) order Cn (OTUCn) Section Monitoring (SM) byte. The measured relative skew can be in reserved bytes in FlexO overhead. The measured skew can be in increments of time measured with reference to a first arriving instance of the multiple interfaces. In an embodiment, the remote transceiver is in a FlexO network having at least two segments with a first segment with the remote transceiver being FlexO transparent based on ITU-T G.709.1 (07/2024) and a second segment with the terminating receiver terminating FlexO based on ITU-T G.709.1 pre-2020. In another embodiment, the remote transceiver is in a FlexO network having multiple FlexO-x regenerator sections. In a further embodiment, the remote transceiver is in a FlexO network having a hybrid FlexO-n regenerator.

### BRIEF DESCRIPTION OF THE DRAWINGS

The present disclosure is detailed through various drawings, where like components or steps are indicated by identical reference numbers for clarity and consistency.

FIG. 1 illustrates a network with legacy and new OTUCn equipment therein for describing a first scenario where an OTUCn must be remotely deskewed,

FIG. 2 illustrates a network with two switches/framers interconnected by multiple FlexO-x regen sections.

FIG. 3 illustrates a network with a hybrid FlexO-n regen.

FIG. 4 illustrates a flowchart of a FlexO remote deskew process at a terminating receiver.

FIG. 5 illustrates a flowchart of a FlexO remote deskew process at a remote transceiver.

FIG. 6 illustrates FlexO basic overhead (BOH).

### DETAILED DESCRIPTION OF THE DISCLOSURE

Again, the present disclosure relates to systems and methods for Flexible Optical Transport Network (FlexO) remote deskew. The remote deskew is used in various scenarios where a receiver is unable to deskew as the skew is beyond its limits. The term “remote” means the deskew function can be performed at locations in the backwards direction of the receiver that is unable to deskew, based on signaling in the overhead. Of note, the standards referenced herein only define a local receiver deskew function.

The remote deskew may be implemented in coherent optical modems as well as any device that creates or terminates the FlexO group. Also, the coherent optical modems can be referred to as transponders, transceivers (TR), muxponders, etc. For example, a transponder is a device that has a client interface and a line interface, and a muxponder can have multiple client interfaces that are multiplexed onto the line interface. Additionally, these devices can connect to circuitry, such as a switching fabric. A regen includes back-to-back transceivers, e.g., transponder, muxponders, etc. The present disclosure utilizes the term transceiver (TR) and receiver, but those skilled in the art will appreciate various terms are used in the art and contemplated herewith. In particular, the present disclosure focused on the skew at a receiver and signaling skew values for remote deskew.

The following describe three, non-limiting, example scenarios, i.e., the various scenarios referenced above. Those skilled in the art will recognize these are only illustrative and other use cases are contemplated.

### Scenario 1—Legacy OTUCn Equipment in the Network

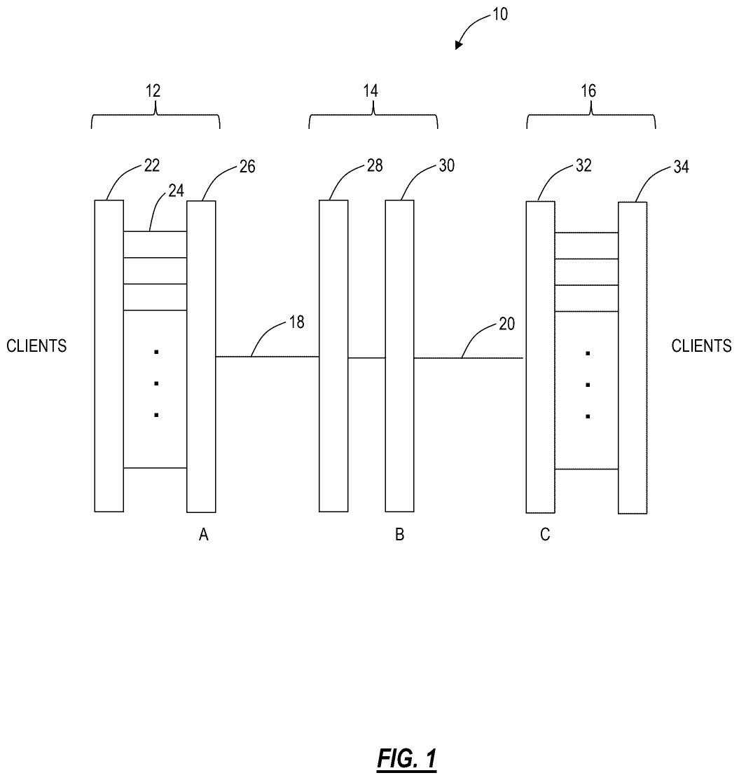

FIG. 1 illustrates a network 10 with legacy and new OTUCn equipment therein for describing a first scenario where an OTUCn must be remotely deskewed. The network 10, for illustration purposes, includes three sites 12, 14, 16, with a segment 18 between the sites 12, 14, and a segment 20 between the sites 14, 16. The segment 18 uses the newer implementation of G.709.1 (07/2024), which is agnostic to the OTUC clients being transported. The site 14 is a regen which connects to the site 16 via the segment 20 which is said to be an older implementation, i.e., the segment 20 uses G.709.1 pre-2020. The older implementation based on G.709.1 pre-2020, only supports a single OTUCn Bit Synchronous Mapping (BMP) (PT=0x00) mapped into FlexO. In an example implementation of scenario 1, the segment 18 is a submarine link, e.g., the site 12 is Sydney, and the site 14 is a landing site in Los Angeles, and the landing site 14 connects a central office in downtown Los Angeles, i.e., the site 16. Of note, those skilled in the art will appreciate the segment 18 does not have to be a submarine link.

The following describes the equipment at the sites 12, 14, 16, as an example. The site 12 includes a switch fabric 22 which includes circuitry for switching OTN signals. The switch fabric 22 has multiple interfaces 24 that connects to a muxponder 26. The muxponder 26 connects to a transponder/muxponder 28 over the segment 18, again using the newer implementation. The transponder/muxponder 28 connects to a transponder/muxponder 30 for a regenerator function. Note, these devices 28, 30 can be either muxponders or transponders. The transponder/muxponder 30 connects to a muxponder 32 over the segment 20, and the muxponder 32 connects to a switch fabric 34.

Accordingly, the devices 26, 28 support the newer implementation over the segment 18, and the devices 30, 32 support the older implementation over the segment 20. A key aspect here is the newer implementation, which supports more advanced deskewing, is located before the older implementation. There are three points A, B, C labeled in FIG. 1 for illustration purposes. The OTUCn at point B (receiver) is present on a FlexO-x-RS or FlexO-x-MFI interface, and must be deskewed by B. As is known in the art, FlexO-x-RS refers to the optical interfaces where x denotes the specific data rate supported by the FlexO interface. The “x” can be replaced by the particular data rate, such as x=1 100 G, x=2 200 G, x=4 400 G, etc., and the RS stands for Reed Solomon (RS) Forward Error Correction (FEC). In the FlexO-x-MFI, the MFI nomenclature stands for Module Framing Interface. The “x” represents the specific data rate or configuration. The MFI is responsible for defining how multiple data streams are combined (multiplexed) and formatted (framed) for transmission over the optical network.

However, in this configuration, the B receiver (at the device 30) cannot correct for the skew introduced on the segment 18 because it exceeds the expected skew for a short-reach interface (300 ns defined in G.709.5). As a solution, the B receiver can communicate back to the A transmitter (or alternatively to B receiver), remotely, to align the interfaces appropriately for the legacy span between B and C. This is OTUCn level deskewing.

Another way to conceptualize the network 10 would be a mix of a newer standard FlexO regens (i.e., between points A, B) mixed with an older standard OTUCn regens (i.e., between the points B, C). FIG. 1 is merely a simple example for illustration purposes, and there are other ways of drawing such applications.

### Scenario 2—Multiple FlexO-x Regen Sections

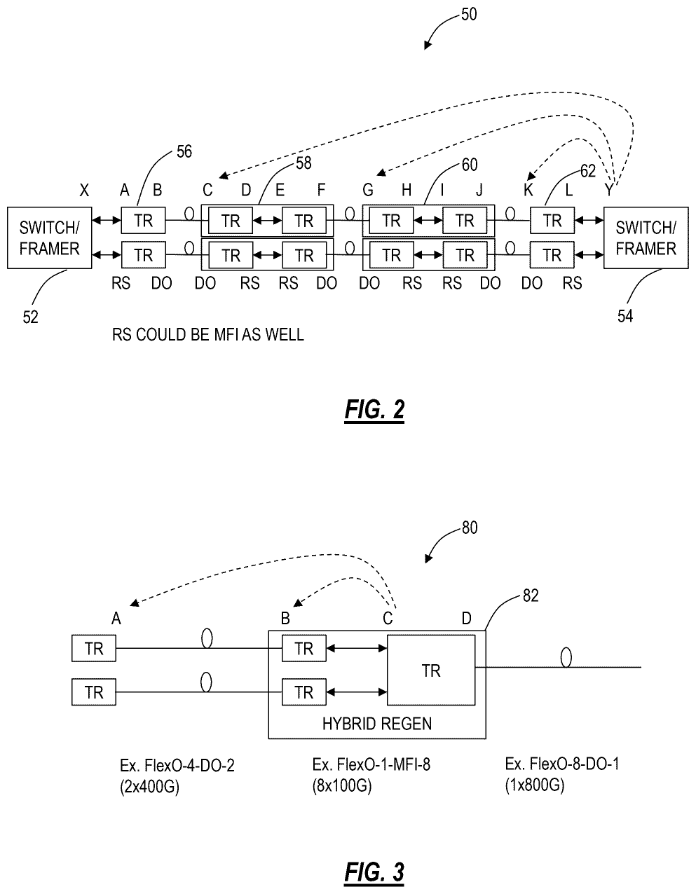

FIG. 2 illustrates a network 50 with two switches/framers 52, 54 interconnected by multiple FlexO-x regen sections. ITU-T G.709.1 and G.798 define a FlexO-x PHY regen. This is FlexO level deskewing. In this example, there are points A-L labeled on the line, and points X, Y at the switches/framers 52, 54 for FlexO terminating nodes. A FlexO-x regen is per wavelength (lambda), is NOT aware of grouping or bonding and does not deskew FlexO instances at the regens. This potentially results in large skew (e.g., due to chromatic dispersion, cabling, etc.) accumulating at the end transceivers (FlexO-x terminating nodes at the points X, Y).

In FIG. 2, there are two sets of equipment, for bidirectional communication. At point X, the switch/framer 52 connects to transceivers 56. The network 50 includes two FlexO regen sections 58, 60, at points C-J, respectively, and which connects to transceivers 62 which connect to the switch/framer 54. Further, the terms “RS” and “DO” are included in FIG. 2 to illustrate the interface types where RS is FlexO-x-RS, which is the client interfaces or electrical MFI, and DO is FlexO-x-DO, which is the coherent line interfaces. DO stands for Digital Signal Processing (DSP) frame+Open FEC (OFEC). It is also noted that FlexO-x-DO coherent interfaces can support different levels of skew. The FlexO regen sections 58, 60 are back-to-back transceivers.

At point Y, the switch/framer 54 may not have enough memory for multi-segment regen deskewing. Typical, devices would be able to deskew up to 1 μs (as per G.709.3/6 requirements). In this example, remote deskewing of the present disclosure can be used to distribute the memory and deskewing functions across multiple receivers (points C, G, K). The receiver or transceiver at point Y can advertise the measured skew and report it back to the other nodes to perform remote deskewing.

### Scenario 3—Hybrid FlexO-n Regens

FIG. 3 illustrates a network 80 with a hybrid FlexO-n regen 82. Again, ITU-T G.709.1 and G.798 define a FlexO-x regen as described in the previous section. This is FlexO level deskewing. However, there are also provisions in the standards to do a FlexO-n hybrid regen 82. This hybrid regen 82 is often called PHY translator where the interface rates are not the same at both ends. That is, the hybrid regen 82 includes back-to-back transceivers with different rates.

For example, there are points A, B, C, D in FIG. 2, and FlexO-x-DO-m is not equal to FlexO-y-DO-m. In an example, the hybrid regen 82 has a FlexO-4-DO-2 interface between points A, B (2×400 G), a FlexO-1-MFI-8 inside the hybrid regen 82 between points C, D (8×100 G), and a FlexO-8-DO-1 from the point D (1×800 G). In this example, the coherent transmitter at point D must have all the FlexO instances aligned in order to create the FlexO-8-DO-1. As described in the first section, a typical RS receiver at point C would not be able to compensate for the skew introduced on segment between the points A, B. Remote deskew can be used here so that the transceiver or receiver at point A and/or point B can compensate for the skew introduced on that segment.

### FlexO Remote Deskew

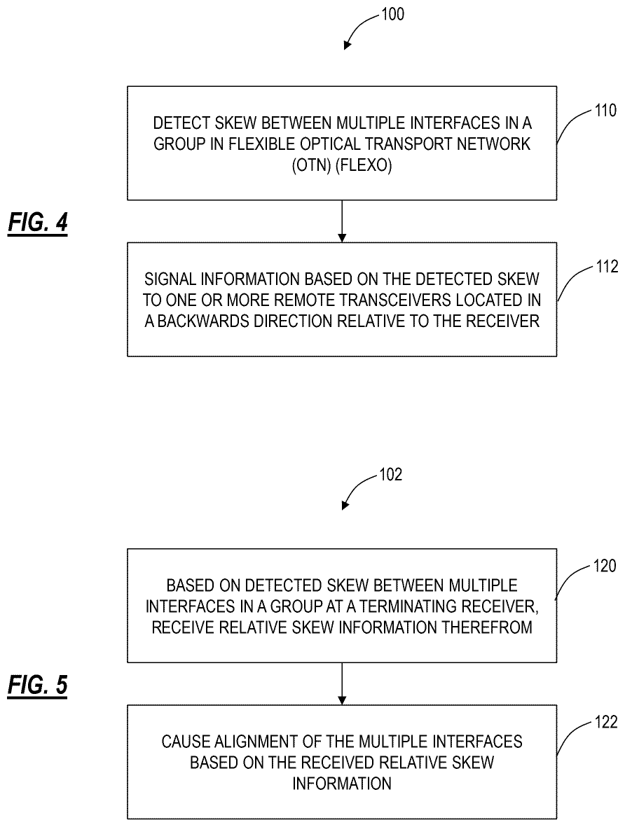

FIG. 4 illustrates a flowchart of a FlexO remote deskew process 100 at terminating receivers. FIG. 5 illustrates a flowchart of a FlexO remote deskew process 102 at a remote transceiver. The FlexO remote deskew processes 100, 102 contemplates implementation as a method having steps and via circuitry configured to implement the steps. The circuitry can be in a transceiver, modem, transponder, muxponder, FlexO regen, etc. The steps generally include two aspects, namely detection of skew at a local receiver and signaling of such skew to remote transceivers, described in the FlexO remote deskew process 100, and receiving the skew at the remote transceivers and the application of deskewing at the remote transceivers based on the received skew, described in the FlexO remote deskew process 102.

The FlexO remote deskew process 100 includes detecting skew across multiple interfaces in a group in Flexible Optical Transport Network (OTN) (FlexO) (step 110), i.e., the skew is measured between the first signal to arrive and the last one, and signal information based on the detected skew to one or more remote transceivers located in a backwards direction relative to the receiver (step 112). Of note, the skew can also be referred to as relative skew as it is between the individual interfaces in the group. The process 100 can further include signaling the information when the detected skew is greater than a value that the receiver can locally deskew. The signaling information can include a backwards deskew failure defect, in FlexO overhead. The information includes a deskew failure indication and a measured relative skew across the multiple interfaces.

The deskew failure indication may be in one of a FlexO STAT byte and an Optical Transport Unit (OTU) order Cn (OTUCn) Section Monitoring (SM) byte. The measured relative skew values can be in reserved bytes in FlexO overhead. The measured relative skew can be in increments of time measured with reference to a first arriving instance of the multiple interfaces. For example, this could be increments of 100 ns using 8-bits, which is up to 25.6 us of skew (more than enough for the longest submarine links). The skew measurements should be relative to the fastest (first arrival) instance and should not be an absolute value given that a common timebase is not known everywhere in the network. Other elements in the network can use the backwards defect and the skew values to compensate (receivers or transmitters) in order to reduce the skew and remove the defect observed at a remote receiver.

The skew values should be semi-stable in a network and can be averaged or periodically sampled. Error bars for FlexO/OTUCn skew should be within 300 ns, which is the minimum as specified in G.709.5. Such a scheme can use Digital Phase Lock Loops (DPLLs) on a transmitter, and slowly bump the phase of the OTUCn or FlexO signals to align the skew. In addition to the FlexO overhead, the information can be signaled in the FlexO Communications Channel (FCC0 or FCC1).

In an embodiment, the receiver is in a FlexO network having at least two segments with a first segment being FlexO transparent based on ITU-T G.709.1 (07/2024) and a second segment with the receiver terminating FlexO based on ITU-T G.709.1 pre-2020. In another embodiment, the receiver is in a FlexO network having multiple FlexO-x regenerator sections. In a further embodiment, the receiver is in a FlexO network having a hybrid FlexO-n regenerator.

The FlexO remote deskew process 102 includes, based on detected skew between multiple interfaces in a group at a terminating receiver, receiving relative skew information therefrom (step 120), and causing alignment of the multiple interfaces based on the received relative skew information (step 122). As described herein, the causing alignment means performing skew adjustment to some acceptable amount of skew. Also, the acceptable amount of skew is the amount that can be compensated in the single, terminating receiver, e.g., typically up to 300 ns. That is, the alignment means performing some remote deskewing because the amount of skew at the terminating receiver is beyond what the terminating receiver is able to compensate locally. The skew information can be received when the detected skew at the terminating receiver is greater than a value that the terminating receiver can locally deskew, and the alignment includes compensating for the skew both at the remote transceiver and the terminating receiver. That is, e.g., when the amount of skew is above 300 ns, some of the skew is compensated at the remote transceiver and some at the terminating receiver. Those skilled in the art will appreciate the alignment is performed remotely and locally.

The received skew information can be signaled in FlexO or OTUCn overhead. The received relative skew information can include a deskew failure indication and a measured skew across the multiple interfaces. The deskew failure indication can be in one of a FlexO STAT byte and an Optical Transport Unit (OTU) order Cn (OTUCn) Section Monitoring (SM) byte. The measured skew can be in reserved bytes in FlexO overhead. The measured skew can be in increments of time measured with reference to a first arriving instance of the multiple interfaces.

### FlexO Overhead

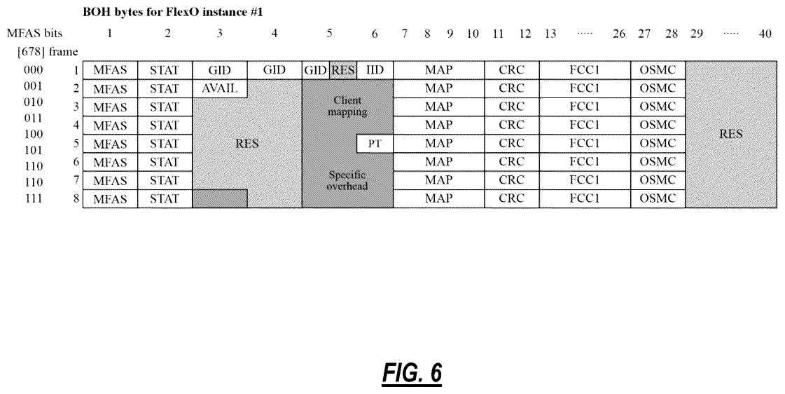

FIG. 6 illustrates FlexO overhead. In an embodiment, the signaled information can be anywhere in the FlexO overhead.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. That is, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments. Also, in the claims, the terms “comprise,” “comprises,” “comprising,” “include,” “includes,” and “including” are intended to be non-limiting and open-ended. These terms specifically list essential elements or steps but do not exclude additional elements or steps. This applies even when a claim or series of claims includes more than one of these terms.

What is claimed is:

1. A receiver configured to support remote deskew, the receiver comprising circuitry configured to:
detect skew between multiple interfaces in a group in Flexible Optical Transport Network (OTN) (FlexO), and
signal information based on the detected skew to one or more remote transceivers located in a backwards direction relative to the receiver.

2. The receiver of claim 1, wherein the circuitry is further configured to signal the information when the detected skew is greater than a value that the receiver can locally deskew.

3. The receiver of claim 1, wherein the information is signaled in FlexO overhead.

4. The receiver of claim 1, wherein the information includes a deskew failure indication and a measured relative skew across the multiple interfaces.

5. The receiver of claim 4, wherein the deskew failure indication is in one of a FlexO STAT byte and an Optical Transport Unit (OTU) order Cn (OTUCn) Section Monitoring (SM) status byte.

6. The receiver of claim 4, wherein the measured relative skew is in reserved bytes in FlexO overhead.

7. The receiver of claim 4, wherein the measured relative skew is in increments of time measured with reference to a first arriving instance of the multiple interfaces.

8. The receiver of claim 1, wherein the receiver is in a FlexO network having at least two segments with a first segment being FlexO transparent utilizing ITU-T G.709.1 (07/2024) and a second segment with the receiver terminating FlexO utilizing ITU-T G.709.1 pre-2020.

9. The receiver of claim 1, wherein the receiver is in a FlexO network having multiple FlexO-x regenerator sections.

10. The receiver of claim 1, wherein the receiver is in a FlexO network having a hybrid FlexO-n regenerator.

11. A remote transceiver configured to support remote deskew in a Flexible Optical Transport Network (OTN) (FlexO) network, the remote transceiver comprising circuitry configured to:
based on detected skew between multiple interfaces in a group at a terminating receiver, receive relative skew information therefrom, and
cause alignment of the multiple interfaces based on the received relative skew information.

12. The remote transceiver of claim 11, wherein the skew information is received when the detected skew at the terminating receiver is greater than a value that the terminating receiver can locally deskew, and wherein the alignment includes compensating for the skew both at the remote transceiver and the terminating receiver.

13. The remote transceiver of claim 11, wherein the received relative skew information is signaled in FlexO overhead.

14. The remote transceiver of claim 11, wherein the received relative skew information includes a deskew failure indication and a measured skew across the multiple interfaces.

15. The remote transceiver of claim 14, wherein the deskew failure indication is in one of a FlexO STAT byte and an Optical Transport Unit (OTU) order Cn (OTUCn) Section Monitoring (SM) byte.

16. The remote transceiver of claim 14, wherein the measured relative skew is in reserved bytes in FlexO overhead.

17. The remote transceiver of claim 14, wherein the measured skew is in increments of time measured with reference to a first arriving instance of the multiple interfaces.

18. The remote transceiver of claim 11, wherein the remote transceiver is in a FlexO network having at least two segments with a first segment with the remote transceiver being FlexO transparent based on ITU-T G.709.1 (07/2024) and a second segment with the terminating receiver terminating FlexO based on ITU-T G.709.1 pre-2020.

19. The remote transceiver of claim 11, wherein the remote transceiver is in a FlexO network having multiple FlexO-x regenerator sections.

20. The remote transceiver of claim 11, wherein the remote transceiver is in a FlexO network having a hybrid FlexO-n regenerator.
